(19) United States
(12) Patent Application Publication
(10) Pub. No.: US 2014/0162779 A1
(43) Pub. Date: Jun. 12, 2014

(54) Curvate Motion Sensing and Control System

(71) Applicant: Morinoske Co., Ltd., Tokyo (JP)

(72) Inventor: Takuo Kawaguchi, Tokyo (JP)

(73) Assignee: Morinoske Co., Ltd., Tokyo (JP)

(21) Appl. No.: 14/075,843

(22) Filed: Nov. 8, 2013

Related U.S. Application Data
(60) Provisional application No. 61/728,506, filed on Nov. 20, 2012.

(51) Int. Cl. A63F 13/90

(52) U.S. Cl. CPC A63F 13/08
USPC 463/31

(57) ABSTRACT

Gaming system based on curvate movement of a jacketed device which may be a smartphone through space on trajectories determined by a user to provide visual, acoustic or physical output based on the user-determined trajectory of the device where the device has a gyroscope sensor for sensing angular acceleration of the device and an accelerometer for determining the magnitude of any acceleration of the device, the gyroscope sensor and the accelerometer cooperate to track the user-determined trajectory of the device, and the jacket has a rotary member for moving the device through space on the trajectory determined by the user.

### FIELD

The present invention is directed generally to articles adapted to be rotated on a curvate trajectory and, more particularly, to wireless transmission devices such as smartphones and other devices that may be swung or rotated on a curvate trajectory, and include: sensors for tracking and comparing the trajectory of the device, means for transmitting a wireless signal indicative of the trajectory, and means for utilizing the wireless signal.

### BACKGROUND

Swinging, spinning and otherwise rotating an object is a common activity which people engage in for amusement, for exercise, and sometimes even out of boredom. However, no one has previously thought to put such activity to practical use. And, wireless transmission devices such as smartphones adapted to sense, transmit and apply such swinging, such spinning or rotating motion in practical and entertaining applications have certainly not been previously contemplated.

If a way could be found to harness the curvate movement produced by swinging, spinning and otherwise rotating a device like a smartphone that has one or more appropriate sensors to produce practical results or to make possible unique new games, an important advance would be at hand. Embodiments described below comprise such an advance by providing a smartphone having, e.g., an accelerometer sensor with a holder for use by a user in swinging, spinning or otherwise rotating the smartphone, means for tracking the curvate trajectory of the smartphone with the accelerometer sensor and means for transmitting a cellular signal indicative thereof. Embodiments also make it possible to compare this curvate trajectory to a preset trajectory to generate control commands, and to achieve unique new objectives in education and physical/mental rehabilitation. Finally, embodiments can be used for amusement and in competitive games.

Furthermore, in some embodiments, the device which is swung or rotated on the curvate trajectory need not be a smartphone, but rather may be any device equipped for sensing and wirelessly transmitting the curvate trajectory of the device.

### DESCRIPTION OF THE DRAWINGS

In order to aid in understanding embodiments of the invention, it will now be described in connection with exemplary embodiments thereof with reference to the accompanying drawings in which like numerical designations will be given to like features:

Turning now to FIGS. 1A-1D, a smartphone jacket embodiment is illustrated with a fixed, built-in rotary member where FIGS. 1A, 1B, 1C and 1D depict, respectively, front, rear, side and top views of a smartphone jacket embodiment with a fixed rotary member;

FIG. 1E depicts the smartphone jacket embodiment of FIGS. 1A-1D with the smartphone in place and the jacket gripped in a user's left hand;

FIGS. 2A and 2B depict respectively rear and front views of a smartphone jacket embodiment with a pair of fixed, built-in rotary members;

FIGS. 3A and 3B depict, respectively, rear and side elevation views of a smartphone jacket embodiment in which a rotary member is affixed to the rear surface of the smartphone jacket;

FIG. 4 depicts an embodiment of a smartphone jacket with a rotary member joined to the jacket by way of a flexible member;

FIG. 5 depicts an embodiment of a smartphone jacket in which a detachable rotary member with a rotatable and pivotable ring is attached to the back of a smartphone jacket;

FIG. 6 depicts a smartphone mounted in a smartphone holder having a rotary member showing axes of rotation of the holder and the rotary member;

FIG. 7 contains a series of drawings numbered “1” through “6” that illustrate how a user can spin or motionize a smartphone using an exemplary rotary member as in FIGS. 1A-1E;

FIGS. 8A and 8B are respectively front and side perspective views of a device with a rotary member having built in means to measure curvature trajectories and to transmit data wirelessly;

FIG. 9 is a block diagram of the componentry of a smartphone or other appropriate digital device such as a tablet computer that may be used to track the curvate trajectory of such a device, and transmit a cellular signal indicative thereof;

FIG. 10 is a flow diagram illustrating the use of an onboard camera in tracking the trajectory of a smartphone or other appropriate device;

FIGS. 11A and 11B are, respectively, a block diagram depicting the recognition and application of a curvate trajectory using a device that is intended to be spun but has no output capabilities of its own, and illustrations of the device and a receiver unit;

FIG. 12 is a perspective view of a smartphone mounted in a smartphone holder as in the embodiment of FIG. 1 in which a rod-like member is located in the rotary member to facilitate rotation of the smartphone;

FIG. 13 is a block diagram illustrating an algorithm for capturing or tracking the curvate motion of a smartphone or other appropriate device;

FIG. 14 depicts a smartphone with “Play,” “Record,” “Assign” and “Print” functions juxtaposed next to flow diagrams of the application functionalities to measure and visualize a curvate trajectory and, under a gaming embodiment, create matching scores between actual motion and a pre-defined trajectory;

FIG. 15 depicts a series of smartphone displays in which the user matches a curvate trajectory with a trajectory of either a pre-installed figure or a figures he or she created and stored;

FIG. 16 is a screen shot of a pre-defined figure and the user's trajectory tracking that figure;

FIG. 17 is a block diagram showing a work flow applicable to both motion recognition and matching of motion of the smartphone or other device with a predetermined trajectory;

FIG. 18 depicts a series of smartphone displays in which a curvate trajectory corresponding to a desired command is shown;

FIG. 19 is a flow diagram showing an algorithm for creating a pre-defined curvate figure;

FIG. 20 shows a pre-installed figure and a user's trajectory matched against the pre-defined figure;

FIG. 21 is a more concise version of what is shown FIG. 20;

FIG. 22 is a view of a smartphone movement including tilting and return to an initial position;

FIG. 23 is a view of another smartphone movement;

FIG. 24 depicts a series of visualizations of the spin of FIG. 23;

FIG. 25 depicts a series of smartphone displays in illustrating how smartphone commands are assigned;

FIG. 26 depicts an embodiment in which a user can assign different commands to the same trajectory depending on a GPS-determined location;

FIG. 27 illustrates how the user may use an existing image saved on the smartphone and apply a trajectory's motion vector in order to create a distorted version of the image; and

FIG. 28 depicts a motion monitoring mode in which imparted motions are compared to motions saved in a database.

### DETAILED DESCRIPTION

### Jackets and Rotary Members

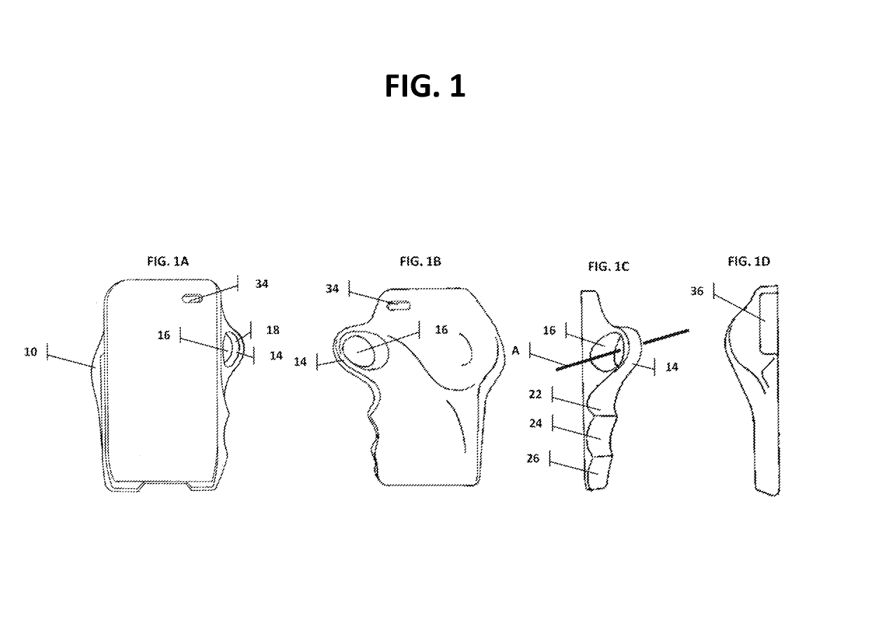

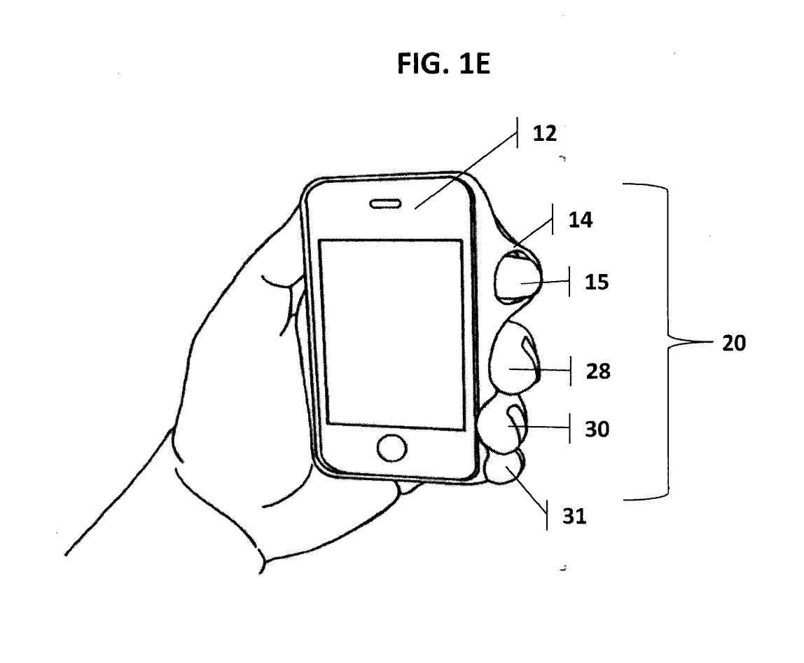

Turning first to FIGS. 1A-D, a smartphone jacket 10 is shown. The jacket enables a smartphone 12 (FIG. 1E) to be spun, swung or otherwise rotated safely on the forefinger by way of a rotary member 14 which also defines a rotation axis “A”. The jacket and smartphone are shown at rest in a user's left hand in FIG. 1E with a user's left forefinger 15 in a circular cavity of rotary member 14 which is formed in this embodiment as an integral part of the overall smartphone jacket.

The rotary member of the smartphone jacket in this exemplary embodiment has a complete circular cavity 16 to receive this user's forefinger. This cavity may, however, be shaped otherwise, e.g., as an oval, a half-moon, a square, a triangle, a spiral, or any other geometric shape. Also, while it is preferred that the outer edge 18 of the cavity be continuous, the edge may be discontinuous with one or more openings so long as no opening is large enough to enable the user's finger to escape the cavity as the smartphone is spun, swung or otherwise rotated.

Jacket 10 also includes an ergonomic shape 20 with finger rests 22, 24, and 26 to receive the user's middle, ring and pinky fingers 28, 30 and 32 to improve the grip on the holder when it is at rest in the user's hand. The jacket also has an optional recess 34 to accommodate the smartphone camera lens as well as a recess 36 for access to the smartphone's controls.

Jacket-mounted smartphone as well as smartphones otherwise provided with rotary members may be referred to herein as being “motionized” to indicate that they are adapted for curvate movement through space on a trajectory that is determined by a user of the smartphone using the rotary member of the holder. Also, by a “curvate trajectory” we mean a trajectory made up of one or more curves or curved segments spaced from the rotary member.

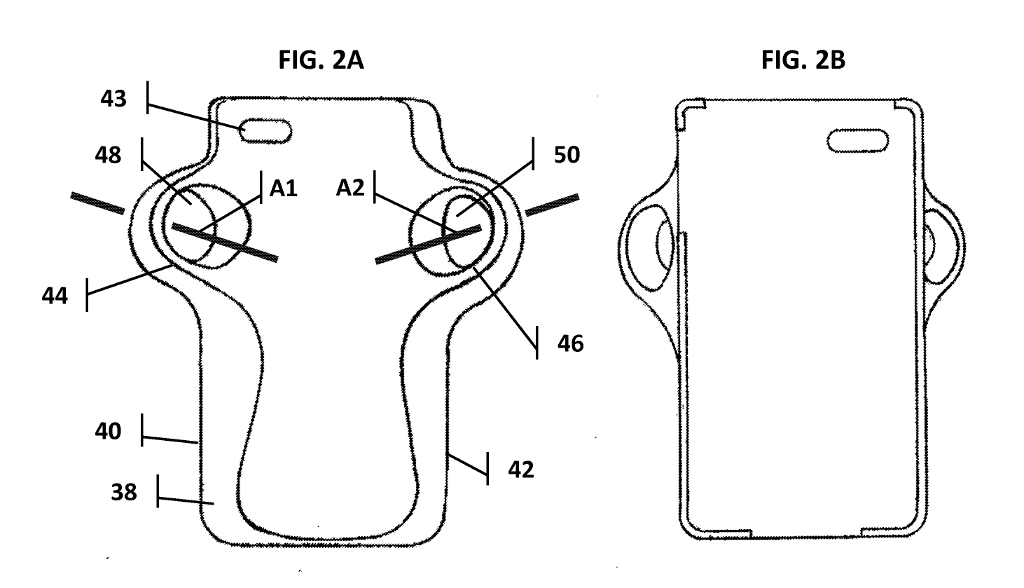

FIGS. 2A and 2B depict a smartphone jacket 38 embodiment with a pair of fixed, unitary rotary members 44 and 46 at opposite lateral edges 40 and 42 of the jacket and a camera lens access opening 43. This embodiment thus enables the smartphone held by the jacket to be spun, swung or otherwise rotated safely on different curvate trajectories at the two rotary members which define spaced-apart rotation axes “A1” and “A2.” The two rotary members enable the smartphone to be held in the user's left or right hand to receive the user's left or right forefinger through cavities 48 or 50 of rotary members 44 and 46.

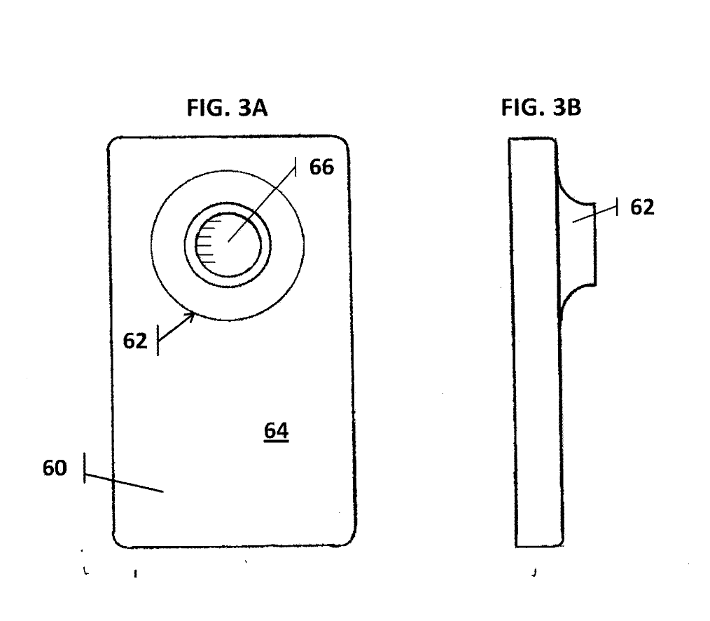

FIGS. 3A and B are views of an embodiment in which a jacket 60 has a rotary member 62 mounted or otherwise fastened to the rear surface 64 of the jacket. This rotary member has a central cavity 66 which receives the end of one of the user's fingers or the end of a rod-like member or similar object held in the user's hand to enable the smartphone to be spun, swung or otherwise rotated safely on a curvate trajectory about the cavity. Rotary member 62 may be an integral part of the jacket, or it may be affixed to a standard smartphone jacket. Also, it may be affixed directly to the back surface of a smartphone.

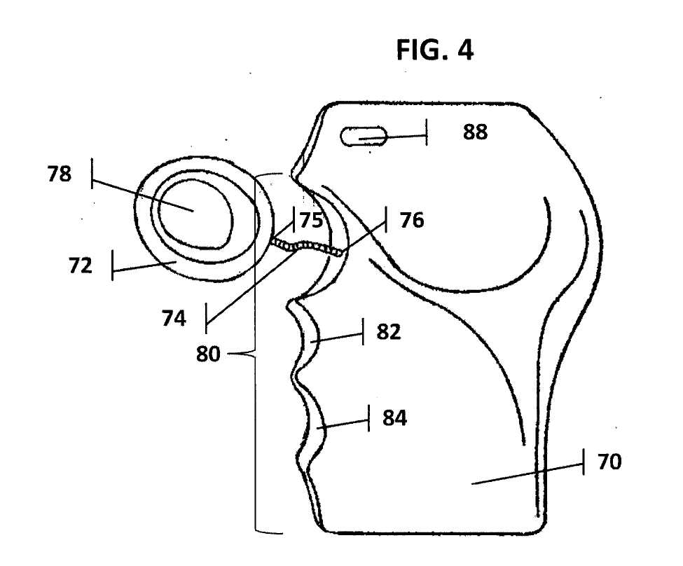

FIG. 4 shows an embodiment in which a rotary member 72 is linked to a jacket 70 through a wire, cord, ribbon, chain, or similar flexible member 74 which is attached to the rotary member at 75 and to the jacket at 76. Member 74 may be stretchable (e.g., an elastic line) or it may be substantially fixed in length.

In this embodiment the user either grasps rotary member 72 or places a finger through cavity 78 in the rotary member to spin, swing, or otherwise rotate the smartphone in the jacket. As this is done, the centrifugal force produced by the movement of the smartphone and jacket about the rotary member will drive the smartphone and jacket away from the rotary member to a maximum distance equal to the cord's length. If the cord is stretchable, the maximum length of the cord as the jacket and smartphone are spun, swung or otherwise rotated will depend on the weight of the jacket and smartphone as well as their velocity and acceleration.

Jacket 70 may have an ergonometric edge 80 adjacent the point of attachment of rotary member 72 with finger rests 82 and 84 to provide an enhanced grip on the jacket when it is being held in the user's hand. A camera lens access port 88 may also be provided.

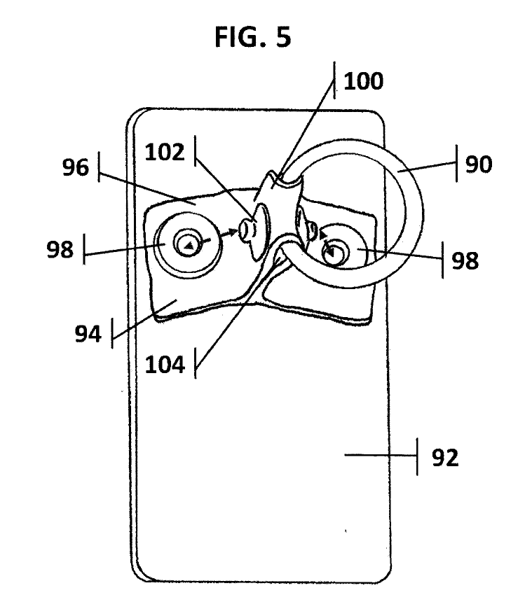

FIG. 5 depicts another embodiment in which a rotary member in a form of a ring 90 is retained on either the back of a smartphone or the back of a smartphone jacket 92 by a ring holder 94. Ring holder 94 may be made of a flexible material such as leather or flexible plastic and includes a base portion 96 which is attached to the back of the smartphone or smartphone jacket by a pair of snaps or rivets 98. The base portion is folded in its middle to produce an upstanding central portion 100 that is pinched together by a snap pair or rivet 102 to form a cavity 104 in which ring 90 is mounted. As is apparent from this figure, the ring may not only rotate within the cavity but may also pivot back and forth across central portion 100 to add interest to the curvate trajectory of a smartphone mounted in a jacket with this structure or a phone to which the structure is directly attached as it is spun, swung or otherwise rotated. Although base 96 is shown bracketed or riveted in place, it may be attached by gluing, sewing, by Velcro, or otherwise. Also, the ring holder may also be made of a rigid material such as metal or hard plastic.

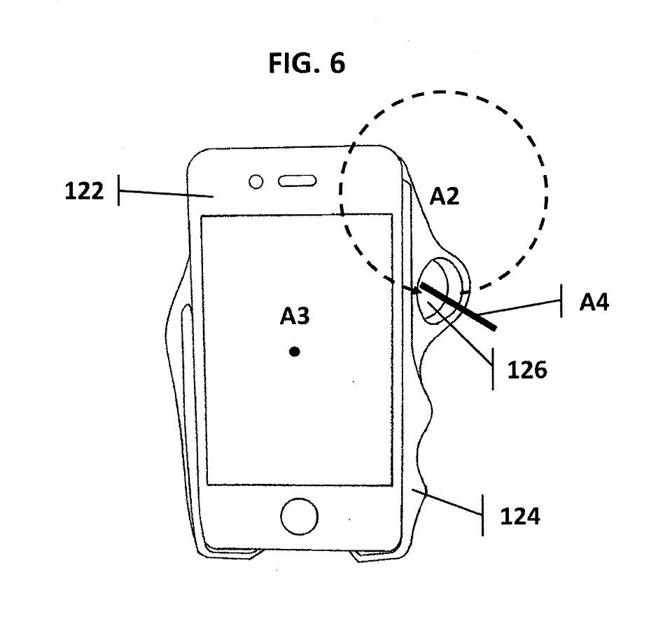

Turning now to FIG. 6, a smartphone 122 is illustrated mounted in a holder 124 having a rotary member 126. Motionized smartphone 122 has a central axis A3 and rotary member 126 has a central axis A4. As can be seen in this Figure, the central axis of the rotary member is offset from the central axis of the smartphone.

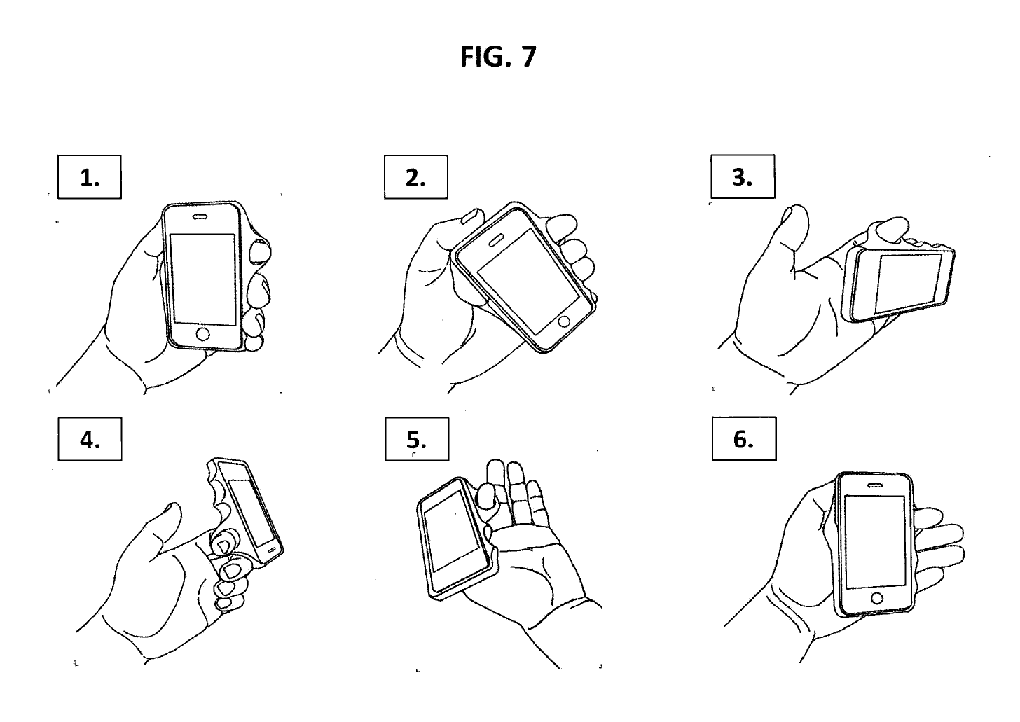

FIG. 7 shows how a user may spin/motionize a jacket-mounted smartphone. Image 1 of FIG. 7 thus shows the jacket with a smartphone friction-fit in the jacket comfortably gripped in a user's left hand. Image 2. shows the reliability of this gripping arrangement since the smartphone remains securely in the user's hand even when tilted as shown. Also, in Image 2. the user's thumb has been moved to the top of the jacket to further secure the jacket and smartphone. In Image 3. the user has now shifted the phone so that it is rotatably balanced on the forefinger of the user's left hand with the forefinger pointed generally upwardly. Again, there is no serious risk of dropping the smartphone.

Now from this position, the user initiates the rotation of the jacket and smartphone through the positions depicted in images 4. and 5. to complete a rotation of 360° or more. Such rotation may be repeated as desired to achieve curvate motion of the smartphone. When this “motionizing” is completed, the smartphone can be swung back into the user's hand as depicted in 6. and securely held there while any of the various available smartphone functions are used.

### Dedicated Device

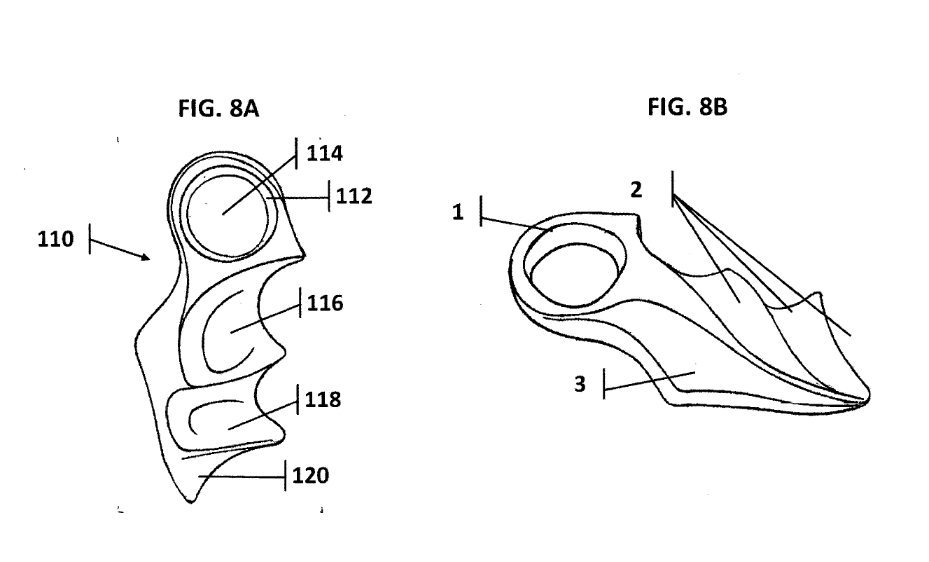

FIGS. 8A and 8B illustrate another embodiment comprising a dedicated device 110 that can be spun, swung or otherwise rotated on a curvate trajectory about a rotary member 112 having a central circular cavity 114. This embodiment does not utilize a smartphone. Rather, dedicated device 110 has its own built-in capabilities to sense the motion, process the data from the sensor and transmit the signal wirelessly. These include an accelerometer sensor, a micro CPU and wireless transmission componentry that enables it to send motion data to a receiving device that is within range, e.g. a smartphone, tablet, other smart mobile devices such as the iPod, PC or TV. Additionally, the ergonometric design of device 110 is particularly well adapted for gripping to receive the user's middle, ring and pinky finger in cavities 116, 118 and 120. This embodiment can be used as a “remote controller” to wirelessly transmits control signals based on its rotation to another device. Control applications are further described below.

### Device Input and Output

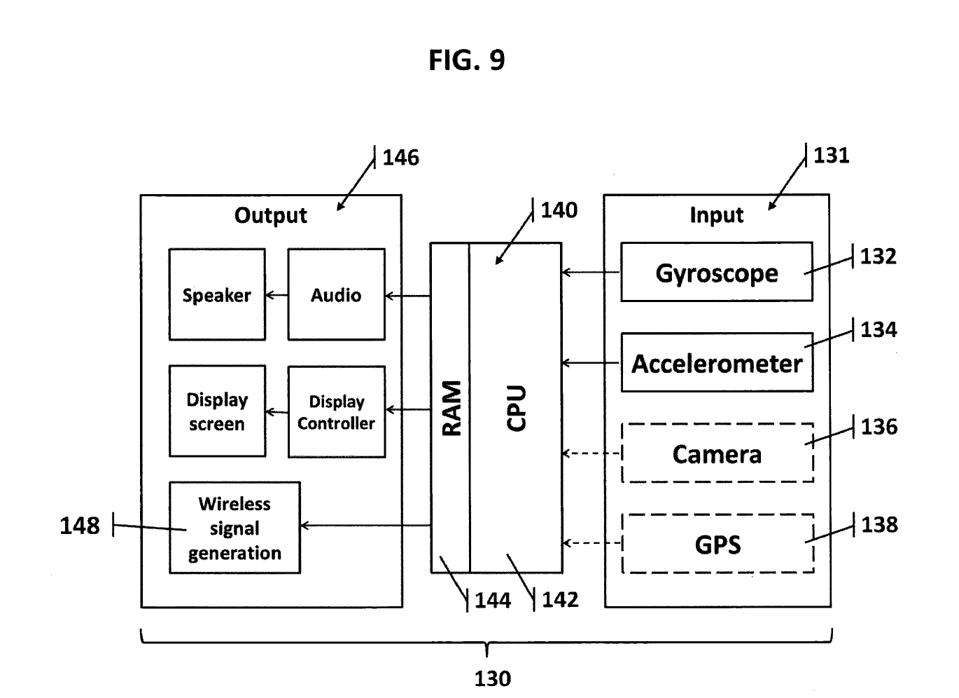

In FIG. 9, the various input, processing and output components present in a smartphone or similar digital device such as a tablet are generally depicted in a block diagram 130. The input components 131 include a gyroscope sensor 132 that senses angular acceleration about the x, z and z axes enabling a precise determination of the yaw, pitch and roll of the device. Preferably, it also includes an accelerometer 134 which measures the magnitude of any acceleration of the device. Both the accelerometer and the gyroscope sensor preferably are located near the central axis of the device. Thus, the gyroscope measures the orientation, while the accelerometer measures the “force” of the movement of the smartphone and combining data from both sensors makes it possible to determine the trajectory of the smartphone with good precision. FIG. 9 thus depicts the transition from motion to output. The output may be in visual form (e.g., a screen showing a score), in acoustic form (e.g., a “congratulatory” voice message) or a physical signal (e.g., vibration of the smartphone).

Optionally, a third less desirable input component may be a camera 136 which can be used as an alternative to either the accelerometer or the accelerometer/gyroscope sensor combination as explained below. The camera, in this application, will capture still images in a narrow sequence of time intervals and compare high contrast reference points. Yet another optional input device is a GPS sensor 138 to generate information about the device's location. While not technically part of the trajectory-recognizing algorithm discussed below, it does generate useful data that can be used as described further below.

The data generated by the input components is processed by the smartphone's processing components 140 including CPU 142 and memory 144. The smartphone is further provided with output components 146 including a wireless signal generator for transmitting a cellular signal indicative of curvate trajectory of the smartphone.

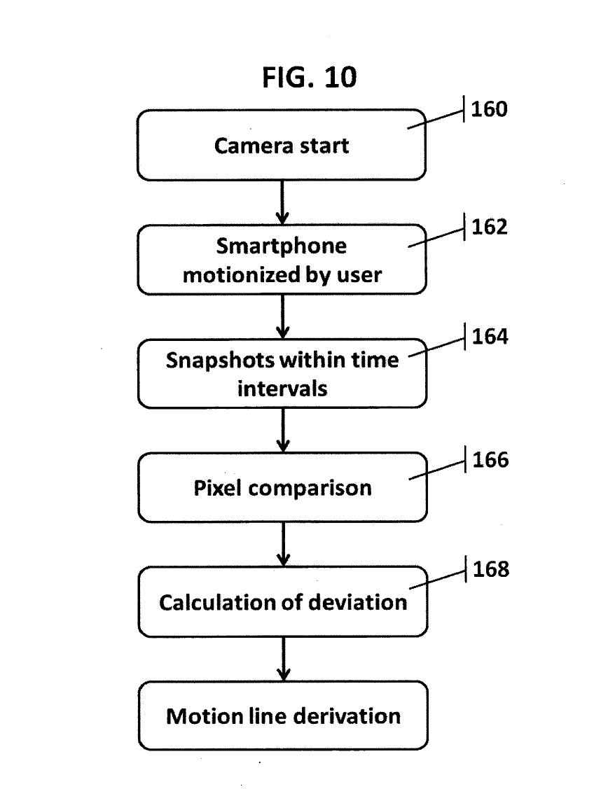

The use of a smartphone camera to determine the smartphone trajectory is illustrated, for example, in the flow diagram of FIG. 10. Thus, the camera of the device will be turned on in step 160. Then the smartphone will be motionized by the user, as described above, in step 162. The device is programmed in this embodiment so that the camera takes a series of snapshots within short time intervals in step 164. A pixel comparison is then made in step 166 and the deviation is calculated in step 168.

Thus, the smartphone software that will cause the camera to take pictures of the environment from its current position within very narrow time intervals comparable to the time intervals in the accelerometer sensor reading. The smartphone's CPU will compare the contrast points on the edges of each image and derive the smartphone's trajectory from the difference between the contrast points.

In yet another embodiment, the motionized smartphone may include a timer for measuring the duration of a curvate trajectory of the smartphone in space as well as to measure the time intervals in which coordinates of the smartphone position are measured by the accelerometer sensor. The timer is used in the motion recognition and is built into a smartphone's CPU and steered by the smartphone's operating system. The system may also count the number of spins within a certain time limit for a game in which the intention is to spin the smartphone as fast as possible.

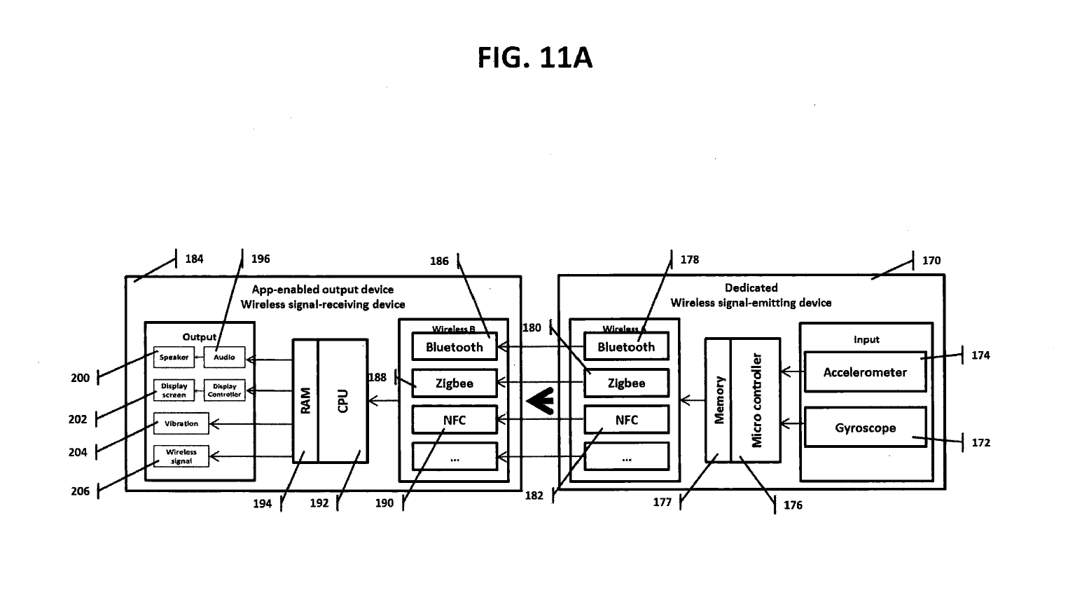

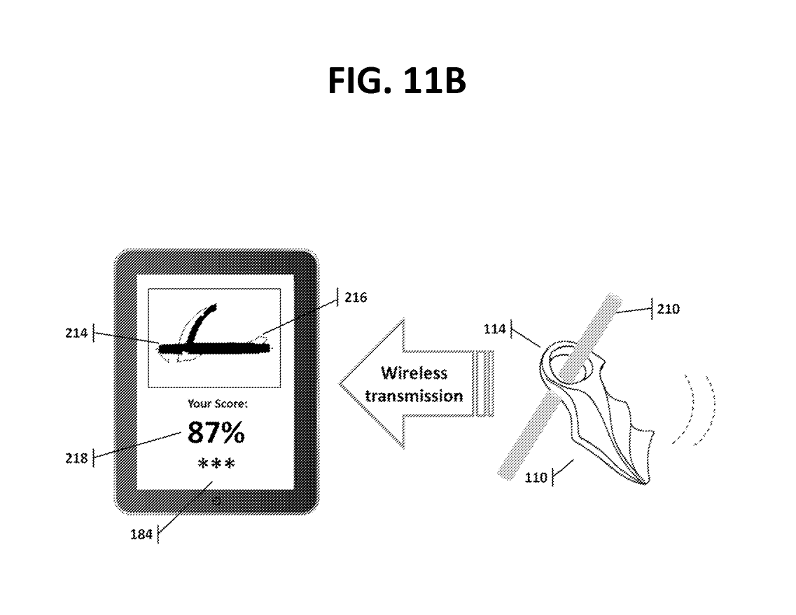

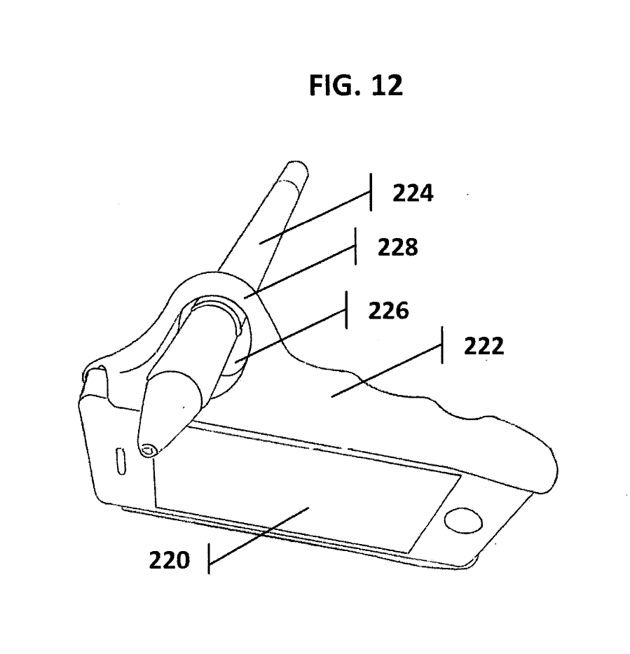

FIG. 11A generally depicts componentry of a dedicated device 170 (e.g., the device 110 of FIGS. 8A and 8B) for recognizing a curvate trajectory and converting the data obtained into effects. This dedicated device will contain a gyroscope 172 and an accelerometer 174 connected to a CPU (micro controller) 176 and memory 177 as well as at least componentry to provide wireless transmission capability (for example Bluetooth 178, Zigbee 180 or NFC 182) so the device can send data to another device that will convert the motion data into output.

Output device 184 can be a tablet, but alternatively could be a smartphone, a PC/laptop or even a television with an operating system that is able to run the appropriate software applications as described herein to process data from dedicated device 170. The output describes how a signal can be converted into sensory information that can be interpreted by a user. This includes visual (through display/screen), acoustic (sound/music) and tactile (e.g. vibration) output. Moreover, the signal can further be transmitted via output device 184 if the device is linked to another output device that cannot be directly reached by input device 170.

Turning now to FIG. 11B, device 110 (as also depicted in FIGS. 8A and 8B) is shown with a rod-like member 210 extending through cavity 114 of rotary member 110 to play a game the challenge of generating ever more coincident curvate trajectories and achieving accurate returns. When the rod-like member is manipulated to cause device 110 to rotate on a curvate trajectory, the trajectory is transmitted wirelessly by way of the componentry depicted in FIG. 11A to output device 184 which, in this case, is a tablet computer. A conventional gesture recognition software application installed on the tablet computer (e.g., an application like $3 Gesture Recognizer whose operation is explained at http://three-dollar-gesture-recognizer.googlecode.com/files/3dollarPoster-%20googleCode.pdf) can be used to display the actual trajectory 214 as well as a target trajectory 216. The system generates a score 218 indicative of the congruence of the actual trajectory with the target trajectory (in this case 87%) and a matching score compares a pre-registered or target gesture/spin trajectory to the actual spin/flip with a score of 100% indicating an exact match to the preregistered “ideal” spin/score. Also, the difference between starting and ending point of the trajectory may also be scored.

As discussed below, in alternative embodiments, commands can be transmitted to external devices. Thus, the smartphone or dedicated device may, in accordance with embodiments of the invention, be provided with local wireless signaling capability and means for transmitting commands to local wireless signal receiving devices. Examples of local wireless signaling capability include Bluetooth, ZigBee, Suica, etc. Thus, such local signals could include, for example, instructions to turn on and off house lights, instructions to turn on and off a television, instructions to change television channels, instructions to turn on or off a video monitoring device, etc.

The software in this invention that is able to visualize the motion and convert it to executable commands is, in a first version, designed to run on mobile devices such as smartphone or tablets and will be outlined further below. However, the same software can be adapted to be installed on desktop devices, TVs, or any device with an operating system that has both wireless transmission capabilities and is able to execute and operating-system based command through display, sound, wireless signals or other information output capabilities. In this case, the possible commands that can be executed are directly linked to the output device's capabilities. For example, commands to a TV could be to turn it on and off, change channels, change the volume, etc.

### Gyroscope Sensor and Classification of Trajectory

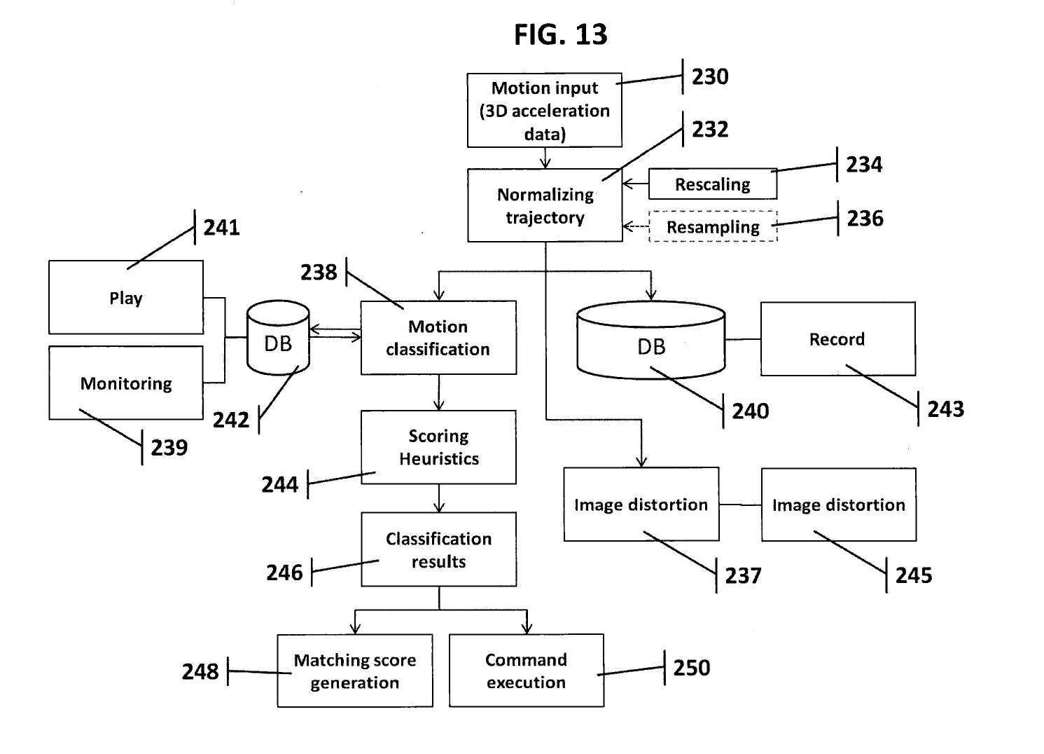

An algorithm that captures the motion of a smartphone or equivalent device is depicted in FIG. 13 to achieve embodiments allowing visualizing curvate trajectories, creating and saving pre-defined trajectories, assigning digital commands to the execution of a motion, and distorting images on the basis for the algorithm's motion vectors. Thus, in FIG. 13, the user executes a motion with the smartphone in step 230 which the accelerometer sensor will read and convert into a vector. Ideally, both gyroscope and accelerometer data will be available and merged into one vector to improve precision. In step 232, the trajectory is normalized to prepare it to be either saved to a database or be compared to stored vectors. This is done by rescaling the motion in step 234, which may be compared to resizing the motion so it fits a 3D box of a certain size. Rescaling helps makes the motion more recognizable. Optionally, the trajectory can also be resampled in step 236, which is a normalization of the motion not in terms of space, but in terms of time.

Once the trajectory is normalized and the vector thus fits a “format”, it will be stored to a database (“DB”) if the user is in “Record” mode (243). If the user enters the “Paint” mode (245) 237, the vector form of the normalized trajectory is applied to change the image by rearranging the pixels according to the trajectory's motion vector. Alternatively, if the user enters either the “Monitoring” mode (239) or the Play mode (241), the two modes that require one vector to be matched against the other, the normalized vector from the actual motion in step 232 will be matched against other vectors stored in the database DB.

In step 244 (scoring heuristics), the software will generate statistics based on the degree of coincidence between the vector created from the actual motion mode and the vector stored in the database DB. Depending whether the Play, Paint or Monitoring mode is active, the scoring heuristics output impacts on the classification of the motion in step 246. The motion is evaluated depending on the parameters defined by the software. In Play mode (step 241), the evaluation generates a matching score (248) reflecting the degree of coincidence between the figure from the database and the actual motion. In Monitoring step 239, the value obtained will determine whether a command will be executed or not (250).

### Exemplary Applications

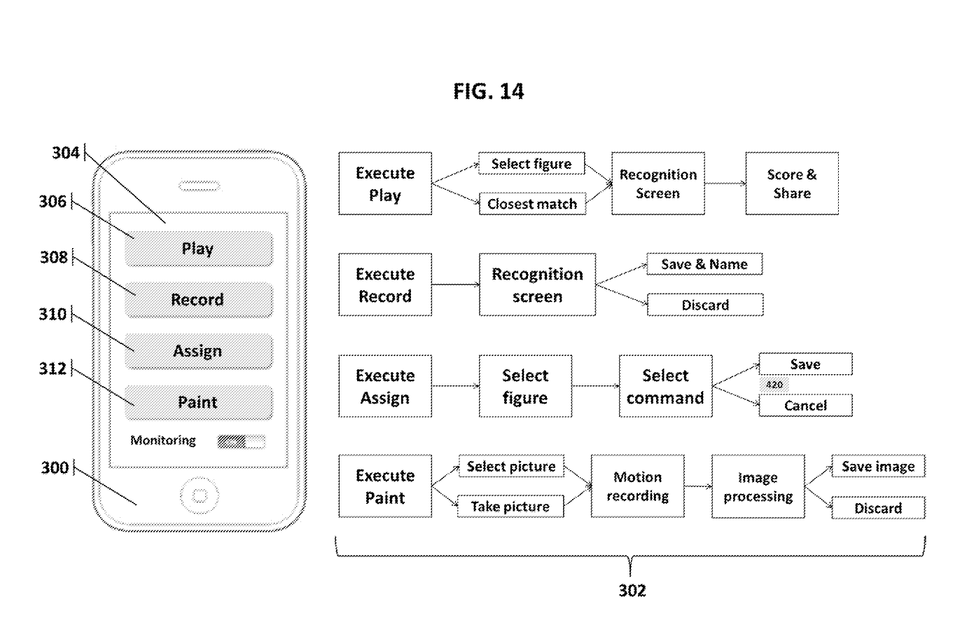

FIG. 14 depicts a wireframe of the smartphone application combined with the main workflow diagrams of the main software application functionalities. This figure thus shows a smartphone 300 in the left side of the figure and a flow diagram 302 on the right. The smartphone display 304 is arranged to provide touch commands of Play (306), Record (308), Assign (310), and Paint (312). These commands are, in turn, illustrated in the self-explanatory flow diagram to the right of the smartphone. Software of embodiments implemented as in FIG. 14 can measure and display the curvate trajectory and, under a gaming aspect of the invention, create a matching score between the actual motion and a pre-defined figure. Pre-defined figures are either pre-installed or can be created by the user under “Record” (300).

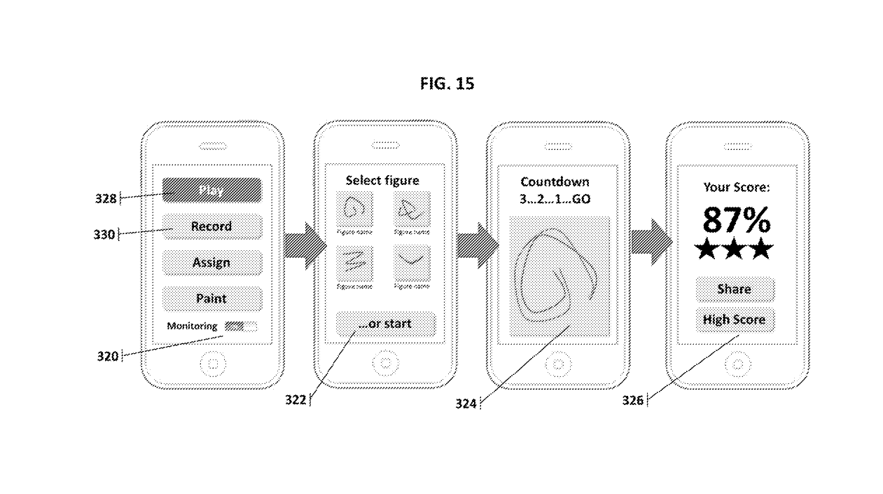

FIG. 15 is a generally self-explanatory flow diagram showing four successive displays 320-326. These four displays thus illustrate the gaming embodiment where the user seeks to match a curvate trajectory with the trajectory of either a pre-installed figure or figures he or she created using the “Record” feature (330) of the system. The closer the trajectory is to the pre-defined trajectory, the higher the score that the user will receive. The system may match of both trajectories on a 3D axis (2-D axis shown for the sake of simplification) and derive a matching score based on the matching algorithm. The score can be shared on social networks such as Facebook or shared with other users for example in competition for high match score.

The gaming embodiment can be initiated by tapping on “Play” (328) which leads to the selection screen 322. The user can select a specific curvate trajectory that he or she wants to match. The trajectories can be selectable through a named screenshot of the figure or simply visually. Alternatively, the user may start the game without selecting a specific figure. In this case, the user's motion may be compared to all figures in the database and matched against the one that comes closest to the trajectory.

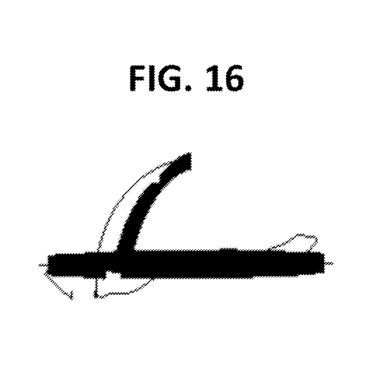

In the illustrated example, the user selects the figure on the upper left side. The start of motion may be indicated through, e.g., a countdown, signaling the user when they should start executing the motion. The system will show the trajectory together with the pre-defined figure as illustrated in screenshot of FIG. 16.

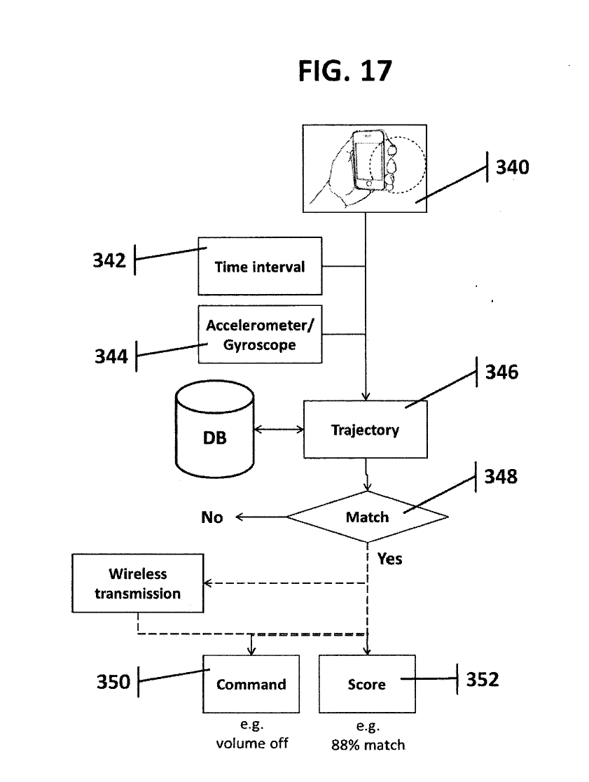

FIG. 17 shows a generally self-explanatory workflow that applies to both motion recognition and matching in the “Monitoring” mode as well as the “Play” mode of the system. Thus, when the user executes a motion at 340, whether from inside the system in the “Play” section or while the Monitoring mode is running, the program will get the values from the accelerometer (and, preferably also from the gyroscope sensor) (344) within the same time interval (342).

Depending in which mode the motion is executed, the end results (command 350 or Score 352) arising from positive Match (348) of the trajectory (346) will differ. In the Monitoring mode, a command such as previously described will be executed; in the Play mode, a score will be generated etc. Alternatively, if the device is not a smartphone but rather a standalone wireless (which could be deemed a “remote controller”) as described above, the data will be transmitted wirelessly to a receiving device that will execute the appropriate result depending on the parameters. For example, if the command is sent wirelessly to a tablet, the command can still be “turn off the volume” (of the tablet).

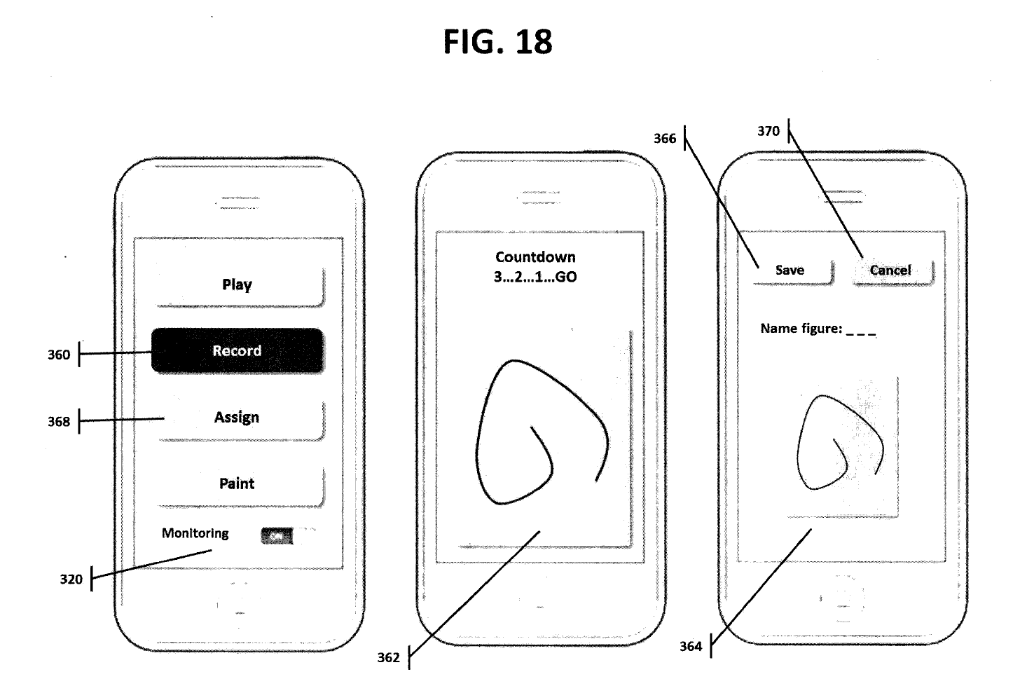

In another important embodiment, a curvate trajectory corresponding to a desired command will be either pre-installed in the smartphone or entered by a user of the smartphone. This is explained in FIG. 18 which depicts a Wireframe in which the “Record” feature (360) allows the user to save a curvate trajectory to the system's database in the form of a sequence of coordinates within narrow time intervals. Upon choosing “Record,” the user will be shown a blank Record screen 362 (without trajection). In the same fashion as described above with respect to the “Play” mode, the user is asked to execute the trajectory he or she wants to record. Once the trajectory is completed, it will be displayed in 362. After the motion is completed the user can either name and save the trajectory (364 and 366) or otherwise convert the motion into a “pre-defined figure” so that he can compete again in “Play,” assign a command by tapping the “Assign” button (368), or cancel the process (370). If saved, the trajectory is available in a list of “Assigned” figures.

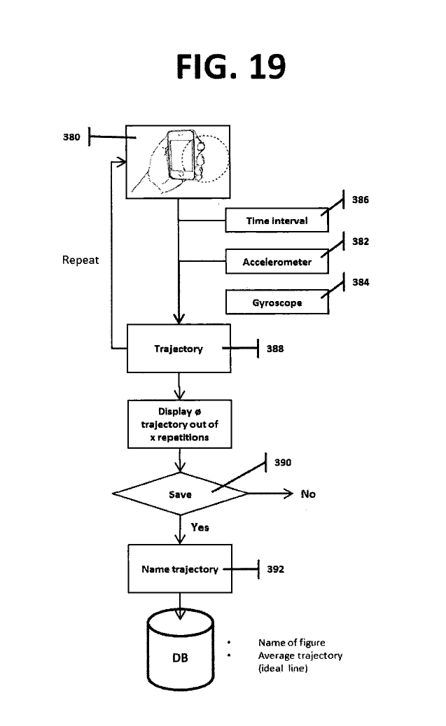

The flow diagram of FIG. 19 shows the steps for creating a pre-defined figure as explained in the previous paragraph. This process applies to both how pre-installed figures and the user-defined figures are created.

Thus, a user who wants to define a certain motion, e.g. a “backward flip”, executes the motion in 380. An accelerometer sensor (382) will generate force vectors (along the x, y, z coordinates) and, optionally, gyroscope sensor (384) will generate position coordinates (also along the x, y, z coordinates). Appropriate software will read those values within defined time intervals (386) from the smartphone's CPU. For example, a time interval of e.g. 100 Hertz would mean generating, e.g., 100 value points per second. The combined data is used to generate data values corresponding to the trajectory (388). The values form a sequential line which in turn forms the motion that can be visualized. The user may repeat the steps, e.g., five times, and the algorithm will compute the average of the five repetitions. This average sequential line of coordinates is the basis for the motion visualization of the average line and corresponds to the screen depicted in 364.

If the user decides to do so, he or she can save the average motion into the program's database by choosing “Save” (390) and assigning a name to the motion (392). Once stored in the database DB, this average line becomes the “pre-defined figure” that the user can try to match in the “Play” section, or he can assign a smartphone command to this figure under “Assign”, e.g. to turn off the volume of the smartphone.

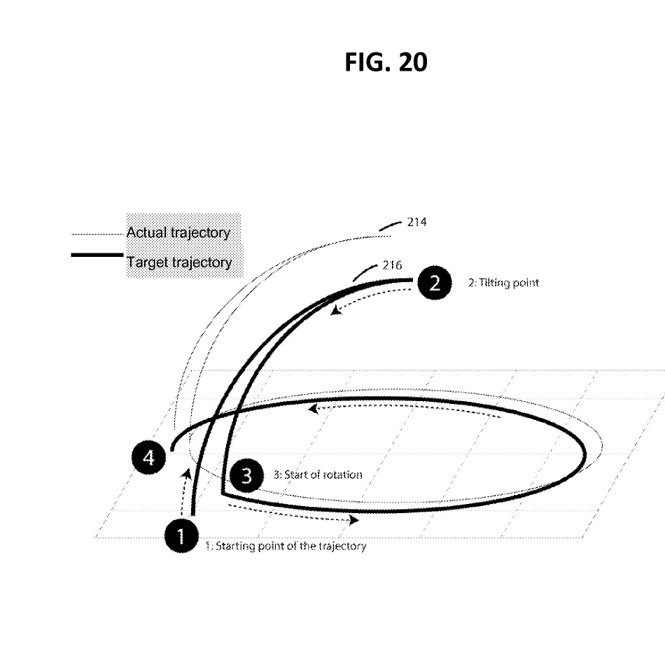

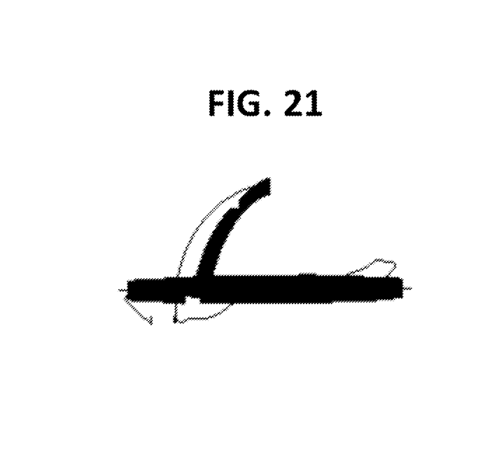

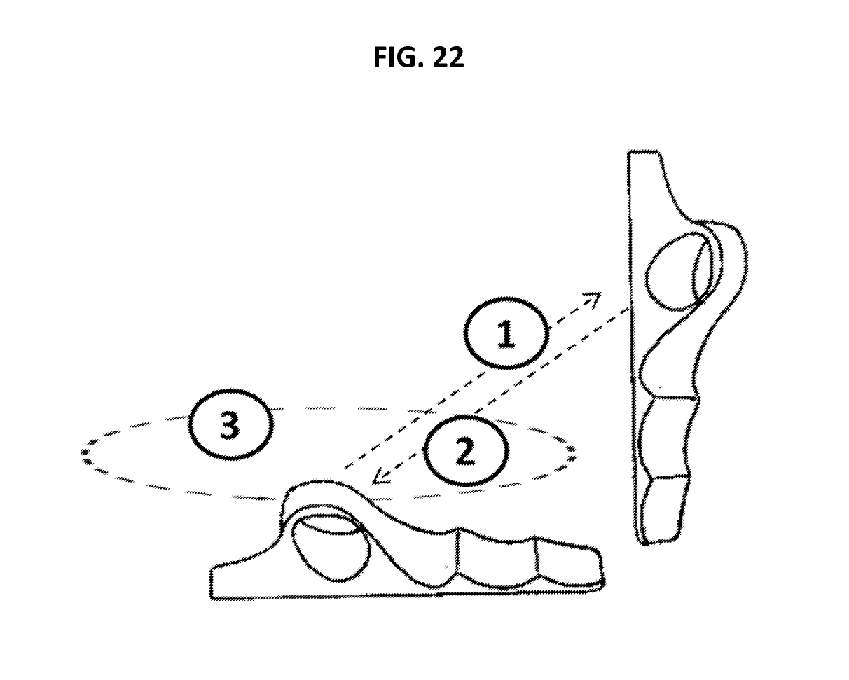

An important functionality of the system is the visualization and matching of the curvate trajectories. The visualization of FIG. 21 shows a pre-installed figure example which may be referred to as “Topple Spin” with FIG. 20 illustrating an edited, more consice version of the actual screenshot of FIG. 21. FIGS. 20 and 21 thus show a simplified matching visualization of a pre-installed figure named for present purposes “Topple spin”. It thus illustrates the actual trajectory as a thin line in FIG. 20 with the “ideal” line shown in bold and labeled as the target trajectory.

This curvate trajectory of FIG. 20 reads as follows:
Point 1: Starting point of the trajectory. The user's starting point deviates slightly from the starting point of the pre-defined trajectory.
Trajectory from starting point 1-to point 2: the device is tilted upwards by about 90° Trajectory from point 2-3: The device is tilted downwards by nearly 90°; the downward tilt deviates slightly from the upward tilt.
Trajectory from point 3-4: Starting at point 3, the device is spun in a nearly 360° circle. Note that the spin executed by the user (thin black line) is in the opposite direction of the pre-defined trajectory (bold black line). The user has therefore made a mistake which will impact on his or her final score.
Point 4: Ending point of the trajectory. The ending point is further away from the starting point than in the ideal (bold black line). This will also negatively impact on the final score.
   As noted above, FIG. 21 is based on the screenshot of the real visualization depicted in FIG. 20. The actual visualization of the trajectory may be animated, showing the trajectory inside a rotating 3D space.

The actual smartphone movement is shown in FIG. 22. Movement “1” of FIG. 21 corresponds to tilting the smartphone upwards by 90°; movement “2” corresponds to tilting it back ideally towards the same exact position. The figure ends with a horizontal spin with starting and ending point ideally being the same (movement “3”).

In the second exemplary figure named for present purposes “Backward Spin”, the user performs a 360° rotation.

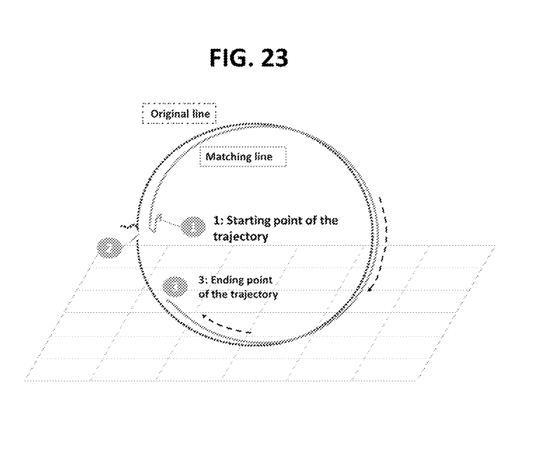

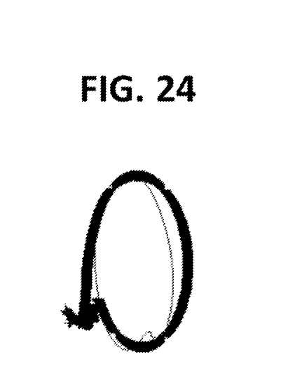

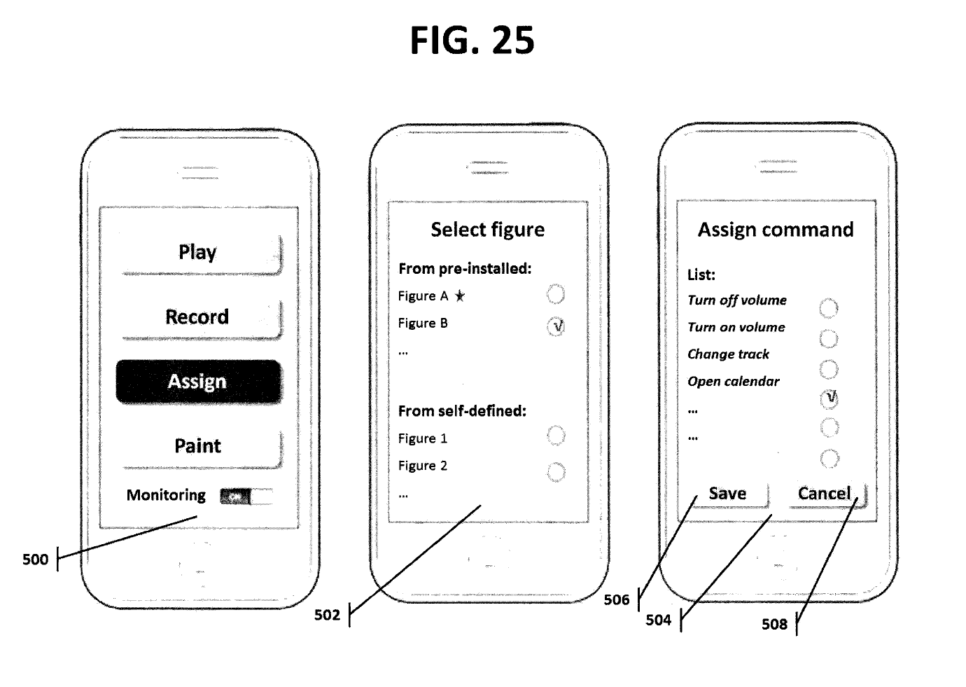

In FIG. 23, the user has to build momentum, which corresponds to the trajectory from point “1” to point “2” in this figure. The trajectory between point 2 and 3 is the rotation of the device along the rotary member also shown in FIG. 2. Point 3 marks the end of the trajectory. Compared to the original line, the user finished the figure away from the starting point 1. This movement is illustrated in FIG. 24.

### Assignment and Application of Commands

In embodiments, smartphone commands may be assigned that are based on the smartphone's operating system to pre-defined as well as pre-installed figures. Examples of commands which may be assigned include, for example, commands to change music player volume, commands to increase or decrease the smartphone display brightness, commands dial a preset number, or commands to open smartphone contacts, jump to the next track of the play list, open the (pre-installed) calendar on the smartphone, open browser, open mailbox, open new mail, lock and unlock smartphone, take picture, start camera, etc.

As illustrated in FIG. 25, the user may assign smartphone commands to the individual figures that are either pre-installed or that the user has defined through a “Record” function described above. On the first screen 500, the user will select the figure he wants to assign a command to from the list of available figures. The star next to Figure A on screen 502 indicates that this Figure already has a command assigned to it. If the user chooses to assign a command to Figure B, Figure B may be marked with a check as shown. In the next screen 504, the user will select from a list of basic smartphone commands. In this case, the user choses to assign the Open calendar command to Figure B. He or she can then save the choice (506) or cancel the procedure (508).

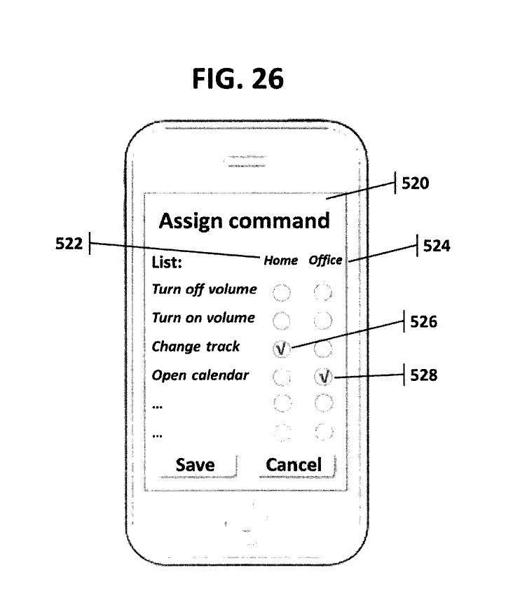

In another version of the system as illustrated in FIG. 26, GPS data from the smartphone can be used to add more options to the Assign feature. FIG. 26 thus shows how the addition of GPS data will alter the screen 504 of FIG. 25. The GPS data is an optional value that can be used to augment the functionality of the “Assign” modus. If available, a GPS sensor can tell the location of the device on the world map, making it possible to assign different commands depending on locations. The user can determine locations using the GPS sensor and name them, e.g. “Home” (522) and “Office” (524) so that the user is able to assign different commands depending on the smartphone's GPS-determined location. For example, if the user is at home, executing a first trajectory can cause the smartphone to jump to the next track if the default music player is playing (526). At the office, the same trajectory can open the smartphone calendar instead (528).

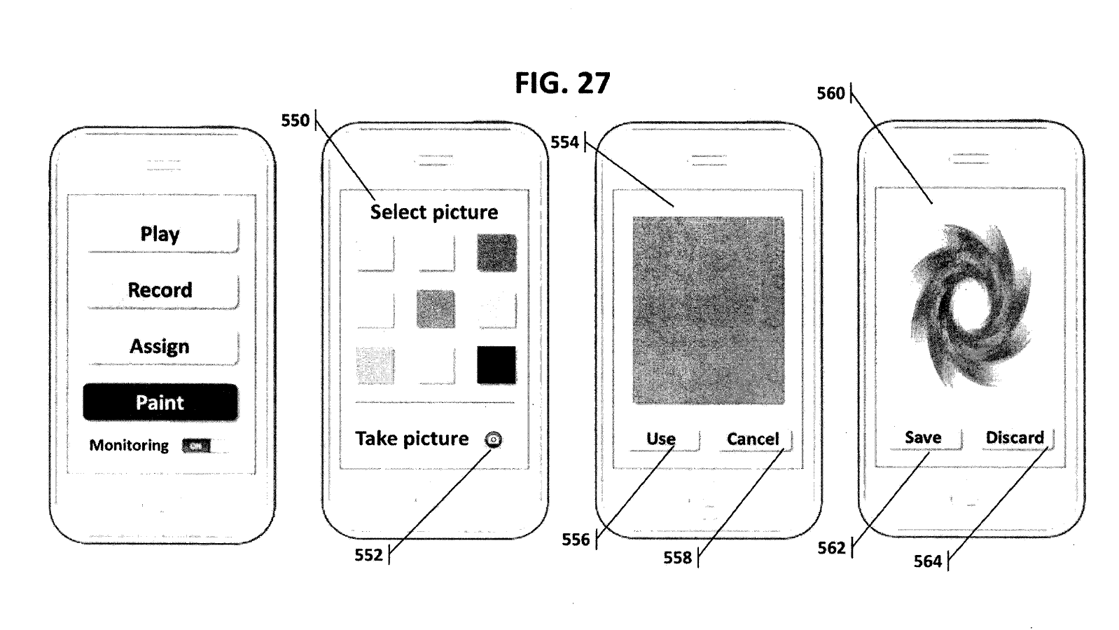

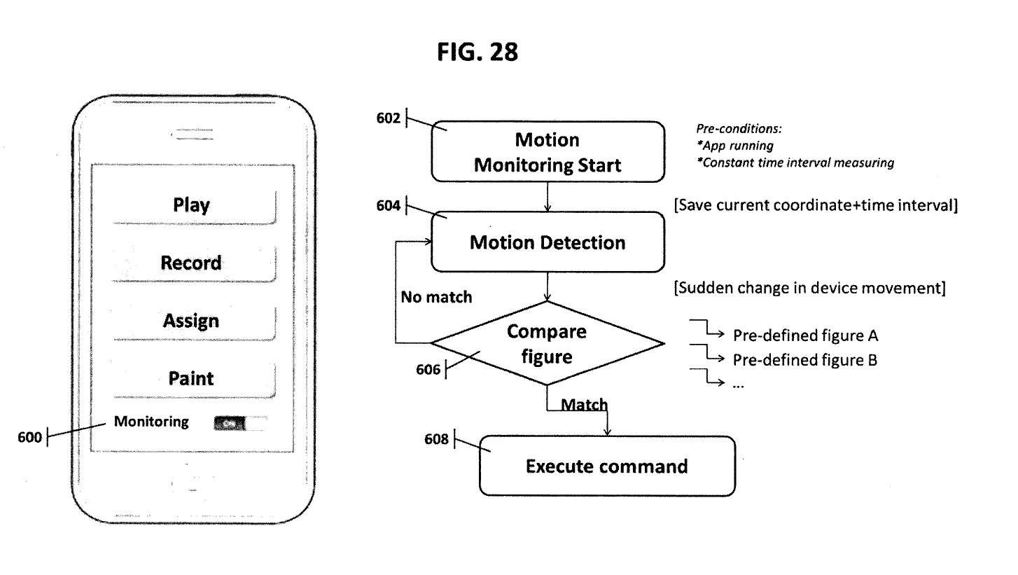

The system also allows applying the motion vectors to distort images, which is covered by the “Paint” feature that can be executed from main menu 500 (FIG. 25). The user will have the option of selecting a picture from his library (550) or taking a new picture (552) as can be seen in FIG. 27. On a confirmation screen he will then be able to confirm his selection (556) or cancel it (558). If confirmed, he will then be asked to perform a motion. The picture's pixels will be rearranged according to the force vectors from the smartphone sensors which are also used to visualize the trajectory. The user will then be able to either save (562) the picture as a different file or cancel the procedure (564).

Paint is included to illustrate one example of what can be done with a rotation or curvate trajectory (spin to distort picture). Other applications include playing virtual “ping-pong”, tennis or Frisbee-like games whereby players use separate jacket-held smartphones or even digital standalones with visualization on a tablet.

The system feature “Monitoring” (600) is illustrated in FIG. 28 and refers to allowing the motion monitoring function to run in the background and to be also active even if the smartphone is on stand-by. This option carries out the motion-to-smartphone-command option that can be edited in “Record” and “Assign”. However, motion monitoring is deactivated while the system is in use. Any changes to Monitoring apply to it working outside the system environment. However, the system will still run in the smartphone's memory. If the monitoring mode is on as shown at 602, the program will check the motion of the smartphone at all times (604), keep a sequence of no more than e.g., four seconds in the smartphone's memory and match it against existing coordinate sequences in the database. Capture and comparison may start if the motion exceeds a certain pre-determined force value generated by the accelerometer sensor if the sequence is close enough to the sequence of the predefined figure. If the trajectory matches any pre-defined figures from the database within the deviation range, the system will execute the smartphone command that was assigned to it in “Assign” described by FIG. 25.

### OTHER APPLICATIONS

The present invention may be used in applications other than in games and to transmit commands. For example, the motionized smartphone may be used for education, for rehabilitation training, for hand training and even as a spin counter.

In a variation of the above single user entertainment system, the system may be adapted for competition between multiple different users of a single smartphone or different users of multiple different motionized smartphones. In this case, means could be provided for uploading scores to a remote location for purposes of collection and comparison to enable interuser competition, ranking, etc.

In embodiments for educational or rehabilitation training purposes, for example, people with motor skill deficits or who simply want to improve their motor skills may use the device to practice and evaluate their progress in accurately duplicating curvate trajectories. For example, the device may be provided with a series of different trajectories which are successively displayed on the display of the smartphone. Taking the holder, the user would attempt to emulate these successive trajectories. Individuals with poor motor skills would be expected to have difficulty in doing this, at least initially. However, as they repeatedly attempt to duplicate the curvate trajectories and see their scores rise as they do so, they will improve their ability to duplicate the curvate trajectories.

The embodiments described above are not intended to be exhaustive or to limit the invention to the precise structures and operation disclosed. Rather, the described embodiments have been chosen to explain principles of embodiments of the invention and their application, and the operation and use of embodiments in order to best enable others skilled in the art to follow their teachings.

The use of the terms “a” and “an” and “the” and similar referents in the context of describing embodiments are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the invention. Preferred embodiments are described herein. It should be understood that the illustrated embodiments are exemplary only, and should not be taken as limiting the scope of the invention.

What is claimed is:

1. A gaming system based on curvate movement of a device through space on trajectories determined by a user comprising:
a device with a central axis and a gyroscope sensor for sensing angular acceleration of the device and an accelerometer to determine the magnitude of any acceleration of the device where the gyroscope sensor and the accelerometer cooperate to track the user-determined trajectory of the device;
a jacket for mounting to the device, the jacket having a rotary member for moving the device through space on a trajectory determined by the user; and
means for providing visual, acoustic or physical output based on the user-determined trajectory of the jacketed device.

2. The gaming system of claim 1 in which the rotary member is adapted for spinning, swinging or rotating the device about a jacket axis offset from the device central axis.

3. The gaming system of claim 1 in which the device includes a wireless signal generator for transmitting a signal indicative of the user-determined trajectory of the device.

4. The gaming system of claim 1 in which the device is a smartphone.

5. The gaming system of claim 1 in which the device includes a GPS sensor for providing information about the location of the device during operation of the gaming system.

6. The gaming system of claim 1 in which the device includes a timer for measuring the extent of movement of the device on the user-determined trajectory within a predetermined time interval.

7. The gaming system of claim 1 in which the rotary member is chosen from the group consisting of: a cavity in the jacket, a member with a cavity fastened to the jacket, and a ring attached to the jacket.

8. The gaming system of claim 1 in which the rotary member is a cavity in the jacket.

9. The gaming system of claim 8 in which the shape of the rotary member cavity is chosen from the group consisting of circular, oval, half-moon, square, triangular and spiral.

10. The gaming system of claim 2 in which the jacket includes two rotary members defining spaced-apart rotation axes.

11. The gaming system of claim 1 in which the jacket includes finger rests for receiving the user's fingers while the user grips the jacket.

12. The gaming system of claim 11 in which the finger rests are shaped and disposed to receive a user's middle, ring and pinky fingers.

13. The gaming system of claim 1 in which the rotary member is affixed to the jacket by a link chosen from the group consisting: a wire, a cord, a ribbon, a chain, a flexible member and a rod-like member.

14. The gaming system of claim 1 in which the rotary member is a ring mounted to the jacket for both rotary and pivoting movement.

15. The gaming system of claim 4 including an output device for receiving the signal indicative of the user-determined trajectory of the device generating a display of the user-determined trajectory.

16. The gaming system of claim 4 in which the output device is chosen from the group consisting of a smartphone, a personal computer, a laptop computer, a tablet computer and a television.

17. The gaming system of claim 15 in which the output device is adapted to display both the user-determined trajectory of the jacketed device and a target trajectory.

18. The gaming system of claim 15 in which the output device is adapted to display both the user-determined trajectory of the jacketed device and a target trajectory in which the output device includes means for generating a score indicative of the congruence of the user-determined trajectory and the target trajectory.

19. The gaming system of claim 18 in which the congruence of the actual trajectory and the user-determined trajectory is determined in three dimensions.

20. The gaming system of claim 17 in which the device includes a plurality of target trajectories and one target trajectory may be chosen from the plurality of target trajectories before initiating the gaming system.

21. The gaming system of claim 20 in which the output device includes means for comparing the camera for capturing images while the device is spun, swung or rotated, the device being adapted to compare contrast points in the captured images to determine the trajectory of the device; trajectory of the jacketed device to the plurality of target trajectories and matching it against the target trajectory that is most congruent to the user-determined trajectory.

22. The gaming system of claim 20 in which the device includes means for creating target trajectories using the device gyroscope sensor and accelerometer.

23. A gaming system based on curvate movement of a device through space on trajectories determined by a user comprising:
a device with a central axis and a camera for capturing images while the device is spun, swung or rotated, the device being adapted to compare contrast points in the captured images to determine the trajectory of the device;
a jacket for mounting to the device, the jacket having a rotary member for moving the device through space on trajectories determined by the user; and
means for providing visual, acoustic or physical output based on the trajectory of the device.

24. A gaming method comprising:
providing a device with a central axis and a gyroscope sensor for sensing angular acceleration of the device and an accelerometer to determine the magnitude of any acceleration of the device where the gyroscope sensor and the accelerometer cooperate to track the user-determined trajectory of the device, a jacket for mounting to the device, the jacket having a rotary member for moving the device through space on a trajectory determined by the user, and means for providing visual, acoustic or physical output based on the user-determined trajectory of the jacketed device;
establishing a user-determined trajectory of the jacketed device; and
providing a visual, acoustic or physical output based on the user-determined trajectory of the jacketed device.
